(19) United States
(12) Patent Application Publication
(10) Pub. No.: US 2023/0375479 A1
(43) Pub. Date: Nov. 23, 2023

(54) MEASURING CELL FOR THE EXAMINATION OF SAMPLES BY MEANS OF ELECTROMAGNETIC RADIATION

(71) Applicant: Reacnostics GmbH, Hamburg (DE)

(72) Inventor: Raimund Horn, Jesteburg (DE)

(21) Appl. No.: 18/199,253

(22) Filed: May 18, 2023

(30) Foreign Application Priority Data
May 20, 2022 (EP) 22174700.9

(51) Int. Cl. G01N 21/75; G01N 21/31

(52) U.S. Cl. CPC G01N 21/75; G01N 21/31; G01N 2201/0636

(57) ABSTRACT

A measuring cell includes beam entry and exit windows, an optical mirror system, and a sample plate. The measuring cell includes flushing gas connections, a mirror system for recording DRIFT spectra, a sample plate having at least 3 spectroscopy chambers fastened thereon, which is connected via a receptacle to a rotating and lifting motor. Each chamber includes a substructure, a sample crucible, and a cover, connected to one another gas-tight and closed off in relation to the surroundings by means. The sample crucible is provided with a drilled hole, through which reaction gas is conducted from an external reactor connected to the measuring cell through the sample material and out of the chamber. Each chamber includes a cover having two cones in which windows transmissive to electromagnetic radiation are inserted and are arranged so that incident radiation and radiation leaving the measuring cell can pass through these windows.

### FIELD OF TECHNOLOGY

The present invention relates to a measuring cell for studying samples by means of electromagnetic radiation, in particular a measuring cell for isopotential spectroscopy, and more preferably a measuring cell for DRIFT spectroscopy in the context of isopotential spectroscopy.

### BACKGROUND

The study of heterogeneously catalyzed reactions is of great scientific and economic importance. However, solid catalysts are dynamic systems which change their structure and reactivity in interaction with their chemical environment. To create structure-effect relationships for such systems, the field of operando investigation of catalytic reactions has continuously developed further in recent times. The goal is always the spectroscopic determination of catalytic activities and states under reaction conditions actually occurring in practice. However, there is a conflict of goals here, since spectroscopic methods such as UV, EPR, IR, NMR, XRD etc. require a special operando measuring cell, which is transmissive, for example, to the electromagnetic radiation applied. In contrast, the reactors used in industrial production for, for example, heterogeneously catalyzed reactions generally consist of steel, which is not transmissive to such radiation.

To solve this problem, so-called isopotential spectroscopy has been developed and refined, the fundamental approach of which is to simulate the reactions running in an industrial reactor and prevailing chemical-physical reaction conditions in a special measuring cell outside the reactor, wherein this measuring cell is suitable for carrying out the desired study method.

Reference is made in particular to WO 2021/078817 A1 and the prior art set forth therein and to DE 199 10 291 A1 with respect to the prior art relevant in this context.

WO 2021/078817 describes the use of isopotential spectroscopy in operando studies of catalytic reactions and a device suitable for this purpose, which includes a reactor for actually carrying out the desired reaction in a larger or industrial scale, which is equipped with a sampling device for gases or liquids from the reactor chamber. Liquid or gaseous samples can be taken along the catalyst bed with simultaneous temperature determination at the sampling location. These samples are transferred via a connecting line into an external measuring cell, which contains the same catalyst as the production reactor and has the same temperature in the measuring chamber. The same chemical environment or the same chemical reaction potential therefore prevails in the measuring cell as in the actual reactor and it is presumed that the same reaction processes are then present in reactor and measuring cell.

Since the heterogeneously catalyzed reactions run or are catalyzed on the catalyst surface, the determination of the surface occupancy of the catalyst is of decisive importance to understand, influence, and therefore also improve the reaction process.

Using the measuring cell according to the invention, various spectroscopic studies, such as IR spectroscopy or DRIFTS, can be carried out to study such heterogeneously catalyzed reactions. The so-called DRIFTS method (diffuse reflection infrared Fourier transform spectroscopy) has proven to be particularly suitable and preferred according to the invention in this case. For a fundamental introduction to this method, see E. H. Korte in Analytiker-Taschenbuch [analytics handbook], Springer-Verlag, Berlin 1990, volume 9, pages 91-123.

Measuring cells for DRIFT spectroscopy and Fourier transform IR spectrometer (FTIR spectrometer) in general form as well as measuring accessories for DRIFT spectroscopy have been well known and commercially available for some time. Such measuring accessories or measuring cells in particular comprise an optical unit, with which incident infrared light can be bundled onto a sample located in its focus, on the one hand, and diffusely scattered infrared light can be collected thereby in the largest possible solid angle range and can be bundled onto a detector or returned back into the spectrometer beam path, on the other hand. This optical unit is usually designed as a mirror system. DRIFT spectroscopy is primarily used for qualitative studies. In contrast, if one wishes to obtain quantitative results, a transformation of the spectrum of the diffuse reflection has to be performed with the aid of the Kubelka-Munk equation.

These commercially available measuring cells have various disadvantages, however, and in particular are not especially suitable and equipped for the described isopotential spectroscopy. Thus, for example, only the sample crucible of such a measuring cell is heated, so that the various substances located in the measuring cell (both educts and products) can condense on the spectral windows and make a measurement significantly more difficult. The cells sometimes have a very large dead volume, which promotes the occurrence of undesired bypass flows. The educts can come into contact with hot metal parts (for example with the heating cartridges used), due to which the recorded spectra have high background contributions, which make an evaluation significantly more difficult or make an evaluation in combination with the profile measurement impossible, because the same chemical potential is no longer provided. The circumstance that usually only one or at most 2 sample crucibles can be measured under the same process conditions is particularly disadvantageous, due to which a complete analysis of the recorded spectra according to the Kubelka-Munk method is not possible (subtraction of various recorded spectra to reach the desired spectrum without background contributions).

The quantification of IR spectra in diffuse reflection takes place by means of the Kubelka-Munk equation and is based on a comparison of the detected radiation intensity to that of a reference substance. This is necessary since the band intensity and also the background spectrum are influenced, inter alia, by the measuring conditions, such as the composition of the sample chamber atmosphere (content of carbon dioxide and water) and the sample preparation. In addition, the location of the baseline is dependent on the temperature and pressure (due to changed scattering coefficients) (Appl. Spectrosc. Rev. 2002, 37, 347-364, doi:10.1081/ASR-120016081). It is therefore necessary to record sample spectrum and reference spectrum under exactly identical conditions, i.e., in direct succession. This significantly restricts the conduct of kinetic studies in cells having only one sample container and the evaluation thereof (ACS Publications, 1993, pp. 351-375).

### SUMMARY OF THE DISCLOSURE

The object of the present invention was therefore to provide a measuring cell improved in various aspects for studying samples using spectroscopic methods or using electromagnetic radiation. In particular, an improved measuring cell for studying samples of heterogeneously catalyzed reactions using DRIFT spectroscopy was to be provided. Its usability for in operando studies in the context of isopotential spectroscopy was also to be ensured if possible.

This object is achieved by a measuring cell as claimed in claim 1 and its special embodiments according to the corresponding dependent claims.

### BRIEF DESCRIPTION OF THE FIGURES

The invention will be explained in more detail hereinafter on the basis of FIGS. 1-8 and their description, without being restricted thereto. This description relates in particular to preferred embodiments and a person skilled in the art will readily recognize known and suitable equivalent features and embodiments thereto, which are also suitable for the purpose according to the invention. All described features also do not have to be implemented at the same time in a measuring cell according to the invention, rather all subcombinations which promote the purpose according to the invention in a suitable manner are also encompassed by the present invention.

FIG. 1 shows a measuring cell 100 according to the invention for isopotential DRIFT spectroscopy.

FIG. 2 shows a longitudinal section through the measuring cell 100.

FIG. 3 shows a sample plate 8 of the measuring cell 100.

FIGS. 4, 5, and 6 show various views and features of the spectroscopy chambers 10 of the measuring cell 100.

FIGS. 7 and 8 show the cover 13 of the spectroscopy chamber 10.

### DETAILED DESCRIPTION

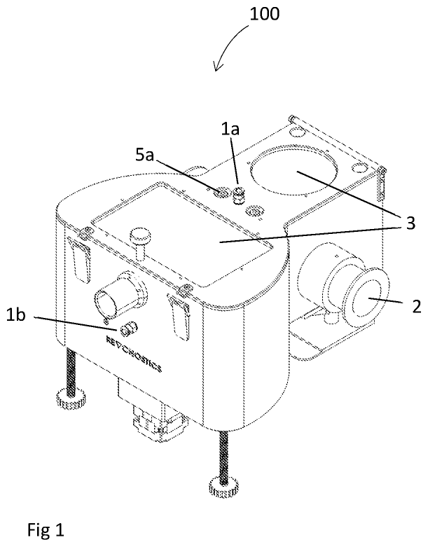

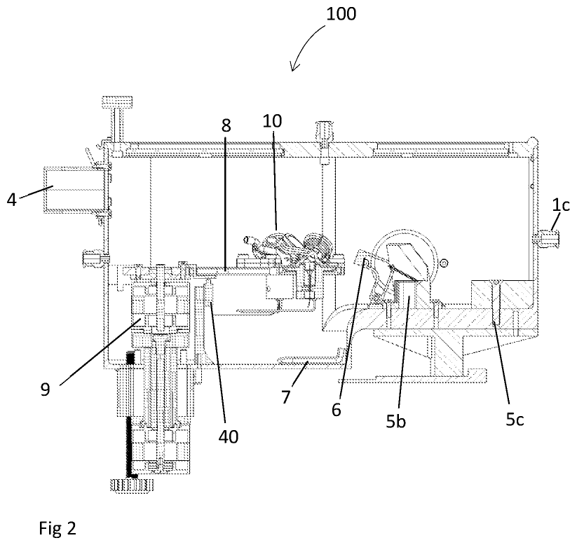

The housing of the measuring cell (FIGS. 1 and 2) preferably consists of anodized aluminum and can be placed directly in the beam path of the IR spectrometer. It represents a sample chamber which is closed as such. It is ensured by flushing gas connections for inert gas (1a-c) that the atmosphere within the chamber can be kept constant during the entire measuring time and therefore variations in temperature and water vapor concentration and also carbon dioxide concentration outside the housing have no influence on resulting IR spectra. On the left and right flank, the housing contains a feedthrough having telescopic arm (2), so that it can be connected to a commercially available FTIR spectrometer. The cover additionally contains windows, preferably made of acrylic glass (3), which are used to observe the sample chamber, and a connection for heated gas lines (4).

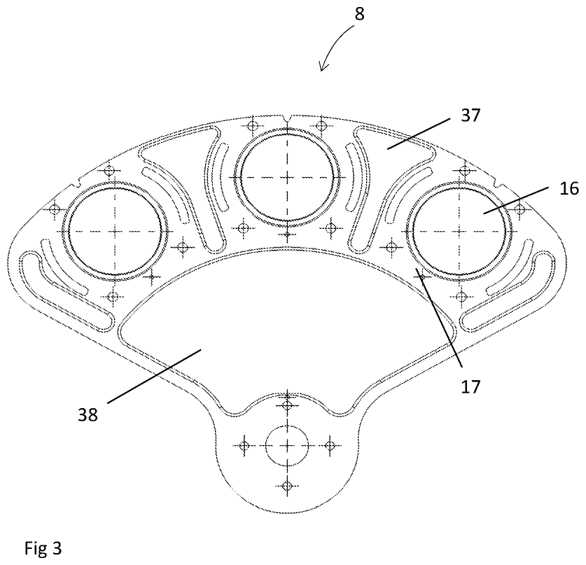

In addition to drilled holes for a commercially available optical mirror system for recording DRIFTS spectra (5a-c), a lock (6) including servomotor (7), which is used for aligning and fixing the sample plate (8) in the horizontal position, is located in the housing. The sample plate (FIG. 3) preferably consists of aluminum, is installed on a rotating/lifting actuator (9) also in the housing and functions as a holder for three spectroscopy chambers (10) identical to one another.

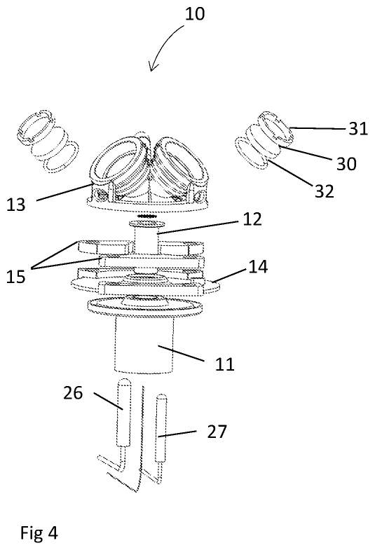

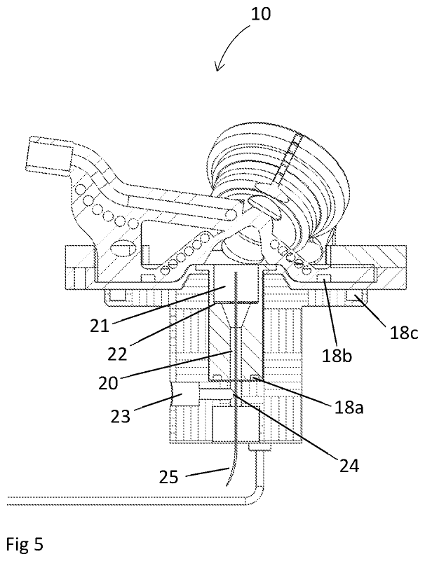

Such a spectroscopy chamber (FIGS. 4 and 5) consists of three component parts: a substructure (11), a sample crucible (12), and a cupola-shaped cover (13). All parts are fixedly connected both to one another and to the sample plate during the measurement via a clamping plate (14) and two clamps (15). For this purpose, the substructure is placed in a depression (16) in the sample plate and subsequently the clamping plate is positioned by means of a register pin (17) on the sample plate. The sample crucible is introduced by the clamping plate into the substructure and pressed against the substructure by means of the cover, which presses against the edges of the crucible in the assembled state. Each of the three component parts includes a ring-shaped cavity (18a-c), in each of which an O-ring is located. These make the interior of the cell gas-tight in relation to the surroundings (18b, c) in the assembled state or seal off the individual components from one another (18a), by the clamps being screwed into the sample plate (19).

The cylindrical sample crucible preferably consists of a thermally conductive ceramic, through the vertical of which a drilled hole goes (20), which is used to conduct the reaction gas through the sample material from the spectroscopy chamber. The drilled hole widens upward to approximately 6 mm, so that it is used there as a sample container (21). It is ensured by the use of a lattice or an inert wadding (22) that the material to be studied is held back in the sample container and that the gas can nonetheless flow through the sample. The use of inserts such as made to measure glass frits and other diameters is also conceivable.

The substructure is manufactured from stainless steel and contains a recess at the upper end, into which the sample crucible can be inserted. A commercially available metal-sealed gas connection (23) is welded on laterally below the end position of the sample crucible. This is used to conduct the gases having reaction products out of the spectroscopy chamber after they have flowed through the sample. It is connected via a drilled hole (24), which divides into three paths and extends in one direction up to the upper end of the substructure, via the sample crucible to the interior of the spectroscopy chamber. The other end of the drilled hole leads to a metal-sealed connection, which is also welded on and through which a thermocouple (25) can be inserted up into the sample fill, sealed off, and fixed. This regulates a heating cartridge (26) placed in the substructure, so that a temperature measurement and temperature regulation to reaction temperature is enabled directly in the sample material. A thermocouple (27) placed in the substructure is used for further monitoring.

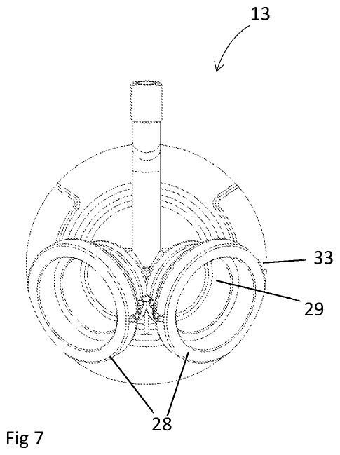

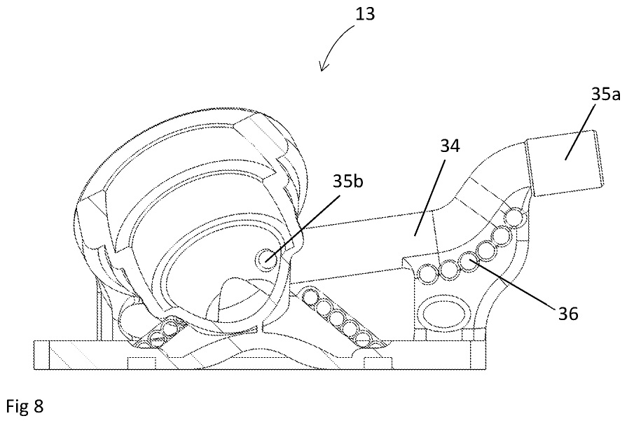

The cover (13, FIGS. 7 and 8) also preferably consists of stainless steel and includes two cones (28), into each of which two drilled holes having internal threads (29) are incorporated. Round infrared-transmissive windows (30) are screwed into these drilled holes and are each sealed off via a window holder (31), PTFE gasket, and O-ring (32) in relation to the interior of the spectroscopy chamber. Up to two measuring windows can be installed per side, between which a small air gap is used as an insulator at higher temperatures. Suitable window materials are, for example, KBr, ZnSe, and CaF₂. The cover is positioned by means of a groove (33) on the sample plate so that the IR radiation is incident through the measuring windows of one side on the sample and on the other side the diffusely reflected radiation can leave the chamber. A channel (34) is incorporated in the cover, at the end of which a commercially available metal-sealed gas connection (35a) is welded on. This is used for the inlet of the reaction gases into the spectroscopy chamber. It is positioned so that the gas flows in below the measuring windows (35b) and is conducted via short dwell paths through the sample material. Large dead volumes are avoided in this way. To avoid condensation or accumulation of condensable reaction gases and/or products both in the cover and on the measuring windows, the cover can be actively heated by means of heating wires. These are not shown in the figure, but can be wound uniformly around the cover and the cone by means of eyes (36) located on the outside of the cover. Temperature regulation takes place here via a thermocouple placed between the cones. The cover itself is preferably embedded in a high-temperature silicone hood for insulation purposes. If reaction gases which can react on stainless steel are used, the cover can be coated beforehand using a chemically inert material.

To avoid overheating of the motor, channels are incorporated on the sample plate for improved heat dissipation. Further removals on the plate, in particular between the spectroscopy chambers (37) and close to the motor receptacle (38), assist the heat dissipation and reduce the weight to be moved. At reaction temperatures above 300° C., it is necessary to actively cool the sealing faces. This can be carried out by a two-part sample plate, in which small channels are incorporated below the sealing faces of the cover and above the face of the substructure, through which a cooling medium is flushed, for example water or silicone oil at higher temperatures. The cooling medium can be guided through the sample plate via hose connections, which are led through the housing. In addition, at very high reaction temperatures, the material of the clamping plate can additionally be selected from a material having poor thermal conductivity, such as ceramic or quartz glass.

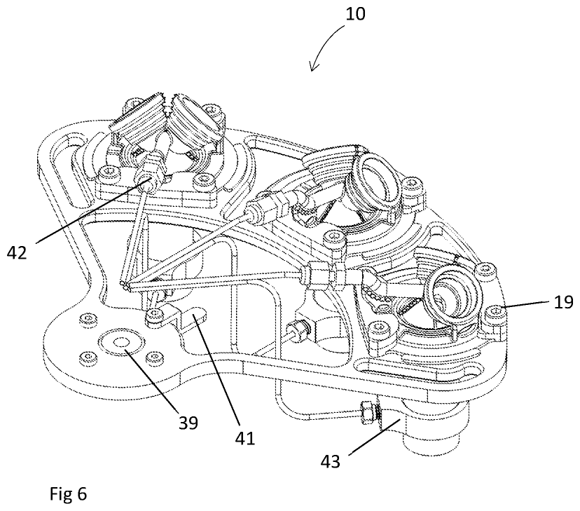

In order that the spectroscopy chambers (FIG. 6) can alternately be brought into the beam path without having to open the sample chamber, these three are fastened on a sample plate. This is connected by means of a receptacle (39) to the rotating and lifting motor (9). The rotating motor is used to move the chambers horizontally in a semicircle, so that the spectroscopy chamber of the sample which is to be measured can be aligned under the mirror optical unit. A lifting movement is additionally necessary before and after the rotational movement in order to avoid a striking of the chamber against the mirror optical unit, which surrounds them very closely in the measuring position. A rotational movement can thus only take place as soon as the spectroscopy chambers are clearly located below the mirror optical unit. The motors are precise stepper motors having very high resolutions, so that a positioning in the micrometer range is enabled and can be carried out reproducibly. Two end switches (40) are placed in the housing, which are used as a reference value for the exact positioning. These can be mechanical switches as shown here (41), or also optical switches such as light barriers.

A supply station (not shown) is used for the gas supply of the spectroscopy chambers, from which supply station, in addition to educts that are gaseous at room temperature, liquid or solid educts can also initially be converted into the gas phase and subsequently can be supplied to the measuring cell. In addition, gaseous samples can also be transferred from a reaction facility into the spectroscopy chambers via heated transfer lines. The transfer of the reaction gases from the gas supply or from the reaction facility into the spectroscopy chambers takes place here by means of a specially manufactured heating hose. This contains six individual lines, which are led bundled from the heated gas supply station to the housing of the measuring cell and are fastened thereon (4). Inside the sample chamber or the housing, the heating hose divides into six separate lines, each heated to setpoint temperature. Per spectroscopy chamber, one line leads to the reaction gas inlet on the cover (42) and one to the reaction (product) gas outlet on the substructure of the chamber (43) in this case.

In addition to the recording of DRIFTS spectra using a catalyst sample, recording solely the gas phase spectrum of the reaction gases flowing into the reaction cell is also of interest. This can be subtracted from the in situ sample spectrum of the catalyst in order to obtain a result spectrum which only shows surface species. This is important in particular if bands of the gas phase molecules overlap with those of the adsorbates.

By using the measuring cell according to the invention, which is particularly suitable for DRIFT spectroscopy, 4 sample measurements, two of which are used to record background spectra and two of which are used to record reactant spectra, can now be carried out in the measuring cell, so that an evaluation using the Kubelka-Munk function is possible. The recording of the spectra takes place here under the exact same conditions as those prevailing in the reactor. Therefore, both gas phase spectra and also surface species on the catalyst surface and therefore the reaction process in the reactor can be reliably determined without high background contributions.

The basic procedure will be described hereinafter. The measuring windows for the entry and exit of the radiation used or arising consist of an infrared-transmissive material, for example calcium fluoride (CaF₂).

The measuring cell consists of three spectroscopy chambers, of which one is filled with an inert material (white standard, for example CaF₂ powder), and two are filled with the catalyst sample diluted in the white standard. The spectroscopy chamber filled with the reference substance is used to record the gas phase spectrum. For this purpose, before each gas phase measurement, a temperature-dependent and pressure-dependent spectrum is recorded using an IR-inactive gas (for example H2) in this chamber. Subsequently, a gas sample taken from the reactor is transferred via a connecting line into this spectroscopy chamber and an additional spectrum is recorded. Subsequent subtraction of the reference spectrum CaF2/H2 from the last-mentioned spectrum results in the spectrum of the gas sample taken.

A second spectroscopy chamber is used to record the reference spectra of the catalyst diluted in the white standard at predetermined temperature and pressure and is continuously flushed using IR-inactive gas. A recording takes place here immediately before measurement in spectroscopy chamber 3. A gas sample taken from the reactor is conducted into the third spectroscopy chamber, which is also filled with diluted catalyst, and a spectrum is recorded. The gas sample taken corresponds here to the sample which is conducted into the first spectroscopy chamber via the pure white standard.

By subtracting the reference spectrum of the catalyst from spectroscopy chamber two from the spectrum from chamber three, a spectrum is obtained which contains both gas phase molecules and catalyst surface species. If the spectrum of the gas sample (spectroscopy chamber 1) obtained in the first step is subtracted from this spectrum, one finally arrives at the spectrum of the species on the catalyst surface, which is essential for understanding the heterogeneously catalyzed reaction.

Since the 3 spectroscopy chambers can be moved alternately into the IR beam with completely identical measurement conditions (IR source, detector sample chamber/housing), the ultimately obtained spectrum is substantially free of background contributions interfering with the evaluation. In addition, it is possible to represent the pure gas phase and the surface species completely independently of one another.

In summary, the essential features and advantages of the measuring cell according to the invention can be represented as follows:

reference and catalyst are measured under identical conditions corresponding to the conditions in the actual reactor; 3 spectroscopy chambers ensure identity of radiation source, detector, and sample chamber in each measurement,

cover of the measuring cell/dome having gas inlet directly below the measuring windows results in small dead volume, no bypass flows; 2 measuring windows per side, windows heated by heating wire means no condensation of educts or products on the measuring windows and the dome,

little contact between reactants and metal parts, temperature control in the catalyst fill (sample fill), equipment and adaptation for isopotential spectroscopy.

### LIST OF REFERENCE SIGNS

100 measuring cell (DRIFTS measuring cell)
1a-c flushing gas connections for inert gas
2 telescopic arm
3 windows
4 heated gas lines
5a-c optical mirror system for recording DRIFT spectra
6 lock
7 servomotor
8 sample plate
9 rotating/lifting actuator
10 spectroscopy chamber
11 substructure
12 sample crucible
13 cover
14 clamping plate
15 clamps
16 depression
17 register pin
18a-c cavity
19 screw connection
drilled hole
21 sample container
22 inert wadding/lattice
23 gas connection
24 drilled hole
25 thermocouple
26 heating cartridge
27 thermocouple
28 cone
29 drilled hole having internal thread
30 IR-transmissive window
31 window holder
32 PTFE gasket and O-ring
33 groove
34 channel
35a gas connection
35b inflow point
36 eyes
37 spectroscopy chamber
38 motor receptacle
39 receptacle
40 end switch
41 mechanical switch
42 reaction gas inlet on cover
43 reaction gas outlet

1. A measuring cell for studying samples by means of electromagnetic radiation, which includes beam entry and exit windows, an optical mirror system, and a sample plate, wherein the measuring cell comprises flushing gas connections, a mirror system for recording DRIFT spectra, a sample plate having at least 3 spectroscopy chambers, which are fastened on the sample plate, which is connected via a receptacle to a rotating and lifting motor, by which the chambers can be moved horizontally and rotated into the beam path and aligned under the mirror optical unit, and wherein each of the chambers includes a substructure, a sample crucible, and a cover, wherein these 3 components are connected to one another gas-tight and are closed off in relation to the surroundings by means, the sample crucible is provided with a drilled hole, through which reaction gas is conducted from an external reactor connected to the measuring cell through the sample material and out of the chamber, and each chamber includes a cover having two cones in which windows transmissive to electromagnetic radiation, are inserted and are arranged so that incident radiation and radiation leaving the measuring cell can pass through these windows, wherein the cover includes a channel having a gas connection for introducing reaction gases from an external reactor into the chamber, and wherein the chamber includes a reaction gas outlet in the substructure of the chamber.

2. The measuring cell as claimed in claim 1, which is connected to an external reactor via gas-tight lines for sampling.

3. The measuring cell as claimed in claim 1, wherein the gas connection and the inflow point are arranged so that the gas supplied from the external reactor flows into the spectroscopy chamber directly below the measuring windows.

4. The measuring cell as claimed in claim 1, wherein the cover of the chambers includes heating wires for actively heating the cover and/or the windows.

5. The measuring cell as claimed in claim 1, wherein each spectroscopy chamber includes a thermocouple, which can be inserted up into the sample fill, sealed off, and fixed.

6. The measuring cell as claimed in claim 1, wherein a heating cartridge, which is regulated via the thermocouple, is located in the substructure of the chamber.

7. The measuring cell as claimed in claim 1, which includes a thermocouple in the substructure of the spectroscopy chamber.

8. The use of a measuring cell for DRIFT spectroscopy of heterogeneously catalyzed reactions.

9. The use as claimed in claim 8, wherein the measuring cell is used as a device in isopotential spectroscopy.

10. The use as claimed in claim 8, wherein the measuring cell is connected to an external reactor via gas-tight lines.

11. A method for studying heterogeneously catalyzed reactions by means of DRIFT spectroscopy, wherein a measuring cell as claimed in claim 1 is used.

12. The method as claimed in claim 11, wherein the study is carried out by means of isopotential spectroscopy.
